(19) United States
(12) Patent Application Publication
(10) Pub. No.: US 2006/0125402 A1
(43) Pub. Date: Jun. 15, 2006

(54) Method for filling a lamp with gas and a lamp filled with gas

(76) Inventor: Johannes Franciscus Meeuwsen, (US)

Correspondence Address: PHILIPS INTELLECTUAL PROPERTY & STANDARDS, P.O. BOX 3001, BRIARCLIFF MANOR, NY, 10510, US

(21) Appl. No.: 10/543,203

(22) PCT Filed: Dec. 18, 2003
(86) PCT No.: PCT/IB03/06116

§ 371 Date: Jul. 22, 2005

(30) Foreign Application Priority Data
Jan. 27, 2003 (EP) 03100152.2

(51) Int. Cl. H01J 61/30; H01J 17/16; H01J 17/20; H01J 9/38

(52) U.S. Cl. 313/634; 313/573; 445/38; 445/53

(57) ABSTRACT

A method for filling a lamp with gas and/or other substances. The lamp comprises an envelope (1) of quartz glass having at least one tubular neck portion (3,4). A member (5,6) comprising electric conductor means (7,8,9) is inserted and sealed in said tubular neck portion (3,4). During the sealing operation an opening (10) is maintained between the outer surface of said member (6) and the inner surface of said tubular neck portion (4) to connect the internal space of said envelope (1) with the outside. The opening (10) is closed after the envelope (1) is filled with gas and/or other substances through said opening (10).

The invention is related to a lamp and to a method for filling a lamp with gas and/or other substances, the lamp comprising an envelope of quartz glass having at least one tubular neck portion, whereby a member comprising electric conductor means is inserted and sealed in said tubular neck portion. Such method is disclosed in U.S. Pat. No. 3,205,395.

A lamp according to the present invention may be a lamp employing a filament (e.g., a halogen lamp), or a lamp employing a pair of opposed electrodes (e.g., a metal halide lamp or a high pressure mercury lamp). Such lamp may have an envelope of quartz glass filled with one or more kinds of gas (e.g., Ar and/or Xe) and/or one or more kinds of substances (e.g., Hg and/or metal halide).

There are different known methods for filling the envelope of the lamp with the required gas and/or with the required other substance or substances. One is the so-called tip tube method utilizing a tip tube (or exhaust tube) connecting the inside of the envelope with the outside after the envelope is closed by inserting and sealing said member or members in the tubular neck portion or portions respectively. After the envelope is filled through said tip tube, the tip tube is closed at a location near the envelope by a sealing operation and subsequently the superfluous portion of the tip tube is removed. Another known method for filling the envelope of the lamp is the so-called tip-less method, which does not utilize the tip tube. Thereby the envelope of the lamp is filled through said tubular neck portion before said member is inserted and sealed in said neck portion. Both methods of filling are described in EP-A-1065698.

When employing the so-called tip tube method, the member or members comprising the electric conductor means can be inserted and sealed in the tubular neck portion or portions, respectively, whereby an accurate positioning of the member or members is easy to achieve. The accurate positioning is important for obtaining an optimal light emission of the lamp. The filling operation will be performed after inserting, positioning and sealing of the member, so that it can not disturb the accurate positioning of the member or members. However, when employing the tip tube method a portion of the tip tube will remain on the envelope, so that the wall of the envelope will comprise an unevenness resulting in a disturbance of the radiation of the light and in a weakening of the wall. That may cause problems, especially in compact high pressure lamps.

When employing the so-called tip-less method, the envelope of the lamp may have the optimal shape without any disturbance by the remainder of a tip tube. The envelope is filled with the required gas and/or other substances before closing the envelope by inserting and sealing the said member in the tubular neck portion of the envelope. However, the sealing operation must be performed under complex circumstances such as cooling the envelope to keep the gas and/or other substances in the envelope during the sealing operation.

In case two members has to be sealed in two tubular neck portions, it is usual to insert and seal one member before the envelope is filled with gas, while the other member is inserted and sealed after the required gas and/or other substances are put into the envelope. In practice it has appeared that it is difficult to achieve an accurate positioning of both members with respect to each other under such circumstances and to maintain the proper inner shape of the bulb-shaped portion near the neck portions.

The object of the invention is to provide a method for filling a lamp with gas and/or other substances, whereby the filling operation takes place after the said member is inserted and sealed in the tubular neck portion of the envelope of the lamp.

In order to accomplish that objective, during the sealing operation an opening is maintained between the outer surface of said member and the inner surface of said tubular neck portion, in order to connect the internal space of said envelope with the outside, and said opening is closed after the envelope is filled with the required gas and/or other substances through said opening. Although the opening extends over the length of the member, it is sufficient to close the opening by sealing only a small portion of the opening near the envelope containing the gas, by locally heating the relevant portion of the quartz glass.

Employing this method for filling the envelope of a lamp results in an envelope without any remainder of a tip tube. Furthermore, the member, or the members, can be inserted and sealed in the tubular neck portion, or portions, as the case may be, in an accurate position before the envelope is filled with the required gas and/or other substances. Thereby also an accurate predetermined shape of the inner surface of the space of the envelope containing the gas and/or other substances can be achieved, which shape is important to ensure an optimal functioning of the lamp.

Preferably the method is employed for manufacturing a high pressure discharge lamp, whereby the envelope must be able to resist a high gas pressure, and whereby an accurate positioning of the two electrodes with respect to each other and with respect to the envelope is essential in order to achieve an optimal light emission.

Preferably the member comprises a body of quartz glass which is sealed in said tubular neck portion, whereby the member comprises appropriate electric conductor means for applying power. In one preferred embodiment the member comprises a molybdenum foil conductor embedded in said body, an outer conductor element connected with said foil conductor and extending outside said body in one direction, and an electrode rod connected with said foil conductor and extending outside said body in the opposite direction. After the member is inserted and sealed in the tubular neck portion of the envelope, the electrode rod is positioned inside the envelope in a predetermined position, and the outer conductor element is connected with a contact for supplying electric current to the lamp.

The sealing operation can be performed by heating the relevant portion of the envelope. Thereby the tubular neck portion shrinks around the body of the member and the quartz glass material of both parts, the body and the neck portion of the envelope, fuses together.

In one preferred embodiment the envelope is provided with two tubular neck portions, whereby in each of them a member is inserted and sealed, and whereby said opening is present in one of the neck portions. Preferably, the two tubular neck portions are directed in opposite directions at opposing sides of the envelope. By inserting and subsequently sealing the two members in one operation, an accurate positioning of the two members with respect to each other and with respect to the envelope can be achieved.

In a preferred embodiment the member comprises a substantial cylindrical body of quartz glass corresponding with the substantial cylindrical inside of said tubular neck portion, except for a recessed portion forming said opening.

The recessed portion may be provided in the inner surface of the tubular neck portion, but preferably the opening is formed by a recess in the outer surface of said member, because such recess is easy to produce. The recess may be a flat portion of the substantial cylindrical outer surface of the body of the member, but preferably the opening is formed by a groove in the outer surface of said body. The groove can be a straight groove in axial direction, which can be machined by a grinding operation. The groove may have a width between 0.1 mm and 1 mm and may have a depth between 0.1 mm and 1 mm. Preferably both dimensions are between 0.2 mm and 0.5 mm. Such groove will remain open during the sealing operation whereby quartz glass material of the member and the tubular neck portion fuses. By further local heating of the tubular neck portion in a later stage, the opening can be closed by further fusing of the quartz glass material, after the envelope is filled with the required gas and/or other substances.

The invention furthermore relates to a lamp filled with gas and/or other substances, the lamp comprising an envelope of quartz glass having at least one tubular neck portion, whereby a member comprising electric conductor means has been inserted and sealed in said tubular neck portion, whereby during the sealing operation an opening has been maintained between the outer surface of said member and the inner surface of said tubular neck portion to connect the internal space of said envelope with the outside, and whereby said opening has been closed after the envelope has been filled with gas and/or other substances through said opening.

The invention is also related to a member comprising electric conductor means, whereby the member comprises a body of quartz glass, a molybdenum foil conductor embedded in said body, an outer conductor element connected with said foil conductor and extending outside said body in one axial direction, and an electrode rod connected with said foil conductor and extending outside said body in the other axial direction, whereby the outer surface of the member is provided with a recess in order to form an opening after the member is inserted and sealed in a tubular neck portion.

In one preferred embodiment the body has a substantial cylindrical shape, whereby its cylindrical surface is provided with a recess extending over its entire axial length.

The invention will now be explained by means of a description of an embodiment of a high pressure discharge lamp, in which reference is made to a drawing, in which:

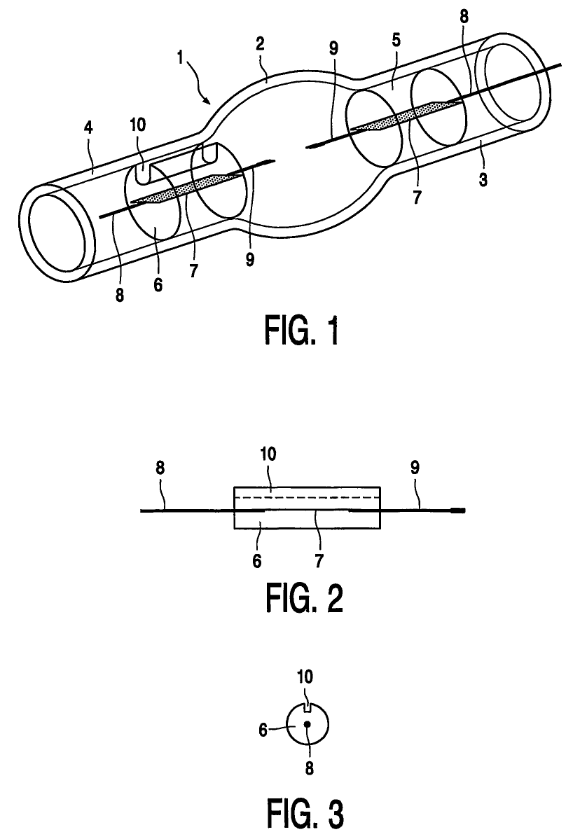

FIG. 1 is a perspective view of the embodiment;

FIG. 2 is a side view of a member comprising electric conductor means; and

FIG. 3 is a front view of the member shown in FIG. 2.

The figures are merely schematic representations of the embodiment, in which some dimensions are out of proportion to achieve a better representation of relevant details.

FIG. 1 shows a transparent envelope 1 made of quartz glass and provided with a central bulb-shaped portion 2 and two tubular neck portions 3,4 extending in opposite directions at opposing sides of the bulb-shaped portion 2. Each of the tubular neck portions 3,4 is provided with a member 5,6 comprising electric conductor means 7,8,9.

Said member 5,6 comprises a body of quartz glass having a substantial cylindrical shape. A molybdenum foil 7 is completely embedded in the substantial cylindrical body. Molybdenum foil 7 is connected to an outer conductor element 8 extending in one axial direction outside said body, and foil 7 is furthermore connected to an electrode 9 extending in the other axial direction outside the body of member 5,6. The two electrodes 9 extend in the bulb-shaped portion 2 of the envelope 1.

As shown in FIG. 1 the two members 5,6 are inserted in the tubular neck portions 3,4 and subsequently sealed. In order to seal the two members 5,6, the tubular neck portions 3,4 are locally heated to a temperature above 2,000° C., whereby the relevant part of the tubular neck portion 3,4 around the member 5,6 shrinks and the quartz glass of the tubular neck portion 3,4 and the body of the member 5,6 fuses together.

After this sealing operation the space in the bulb-shaped portion 2 of the envelope 1 is closed, except for an opening formed by a groove 10 in the outer surface of the body of member 6. The opening 10 may have a diameter between 0.1 mm and 1 mm, depending on the diameter of member 6. FIGS. 2 and 3 show member 6 provided with the groove 10, in two different views.

If necessary, the inside of the bulb-shaped portion 2 of the envelope 1 can be cleaned after the sealing operation with an appropriate gas through said opening 10. Afterwards, the space in the bulb-shaped portion 2 can be pumped and filled through the opening 10 with the required gas and/or other substances, and subsequently the space can be closed by closing the opening 10. Only a portion of opening 10 near said space must be closed and that can be done by locally heating the quartz glass, for example by a laser beam. Before this heat treatment takes place, a small piece of quartz glass may be put in the opening, in order facilitate the closing operation.

Tubular neck portion 4 can be made longer than neck portion 3 in order to facilitate its connection with the pumping and filling device. After filling the bulb-shaped portion 2, the superfluous parts of the tubular neck portions 3,4 can be removed, so that the outer conductor elements 8 extend outside the envelope 1. These outer conductor elements 8 may serve as contacts to cooperate with electrical contact means in the fitting in which the lamp is to be placed. The outer conductor elements 8 may also be connected with such contacts.

In one preferred embodiment the part to be removed from the tubular neck portions 3,4 includes a portion around said member, so that in the final lamp a portion of the member, or both members, extends outside the envelope forming the bulb of the lamp. Thereby the quantity of quartz glass of the lamp can be minimized.

The outer conductor element 8 is for example made of molybdenum, and the electrode rod 9 can be made of tungsten. The molybdenum foil 7 between the outer conductor element 8 and the electrode rod 9 may have a thickness between 0.02 mm and 0.05, a width between 1.5 mm and 5 mm, and a length between 7 mm and 20 mm. The molybdenum foil 7 embedded in quartz glass is a conductor that can resist large temperature changes, in spite of the considerable difference in coefficient of expansion of the materials.

The embodiment as described above is merely an example; a great many other embodiments are possible, including other kinds of lamps, e.g. filament lamps.

1. A method for filling a lamp with gas and/or other substances, the lamp comprising an envelope (1) of quartz glass having at least one tubular neck portion (3,4), whereby a member (5,6) comprising electric conductor means (7,8,9) is inserted and sealed in said tubular neck portion (3,4), characterized in that during the sealing operation an opening (10) is maintained between the outer surface of said member (6) and the inner surface of said tubular neck portion (4) to connect the internal space of said envelope (1) with the outside, and in that said opening (10) is closed after the envelope (1) is filled with gas and/or other substances through said opening (10).

2. A method as claimed in claim 1, characterized in that the lamp is a high pressure discharge lamp.

3. A method as claimed in claim 1, characterized in that the member (5,6) comprises a body of quartz glass which is sealed in said tubular neck portion (3,4).

4. A method as claimed in claim 3, characterized in that the member (5,6) comprises a molybdenum foil conductor (7) embedded in said body, an outer conductor element (8) connected with said foil conductor (7) and extending outside said body in one direction, and an electrode rod (9) connected with said foil conductor (7) and extending outside said body in the opposite direction.

5. A method as claimed in claim 1, characterized in that the envelope (1) is provided with two tubular neck portions (3,4), whereby in each of them a member (5,6) is inserted and sealed, and whereby said opening (10) is present in one of the neck portions (4).

6. A method as claimed in claim 1, characterized in that the member (5,6) comprises a substantial cylindrical body of quartz glass corresponding with the substantial cylindrical inside of said tubular neck portion (3,4), except for a recessed portion forming said opening (10).

7. A method as claimed in claim 1, characterized in that the opening (10) is formed by a recess in the outer surface of said member (6).

8. A method as claimed in claim 1, characterized in that the opening (10) is formed by a groove in the outer surface of the member (6).

9. A lamp filled with gas and/or other substances, the lamp comprising an envelope (1) of quartz glass having at least one tubular neck portion (3,4), whereby a member comprising electric conductor means (7,8,9) has been inserted and sealed in said tubular neck portion (3,4), characterized in that during the sealing operation an opening (10) has been maintained between the outer surface of said member (6) and the inner surface of said tubular neck portion (4) to connect the internal space of said envelope (1) with the outside, and in that said opening (10) has been closed after the envelope (1) has been filled with gas and/or other substances through said opening (10).

10. A member comprising electric conductor means as mentioned in claim 1, characterized in that the member (6) comprises a body of quartz glass, a molybdenum foil conductor (7) embedded in said body, an outer conductor element (8) connected with said foil conductor (7) and extending outside said body in one axial direction, and an electrode rod (9) connected with said foil conductor (7) and extending outside said body in the other axial direction, and in that the outer surface of the member (6) is provided with a recess in order to form an opening (10) after the member (6) is inserted and sealed in a tubular neck portion (4).

11. A member as claimed in claim 10, characterized in that the body has a substantial cylindrical shape, and in that its cylindrical surface is provided with a recess (10) extending over its entire axial length.
